(19) United States
(12) Patent Application Publication
(10) Pub. No.: US 2024/0414759 A1
(43) Pub. Date: Dec. 12, 2024

(54) EXCHANGING LBT INFORMATION BETWEEN RAN NODES

(71) Applicant: Telefonaktiebolaget LM Ericsson (PUBL), Stockholm (SE)

(72) Inventors: Johan Rune, LIDINGÖ (SE); Angelo CENTONZA, GRANADA (ES); Marco Belleschi, SOLNA (SE); Pradeepa Ramachandra, LINKÖPING (SE)

(21) Appl. No.: 18/701,505

(22) PCT Filed: Oct. 21, 2022
(86) PCT No.: PCT/IB2022/060149

§ 371 Date: Apr. 15, 2024

Related U.S. Application Data
(60) Provisional application No. 63/270,101, filed on Oct. 21, 2021.

(51) Int. Cl. H04W 74/0808

(52) U.S. Cl. CPC H04W 74/0808

(57) ABSTRACT

According to some embodiments, a method performed by a first network node operating in shared spectrum comprises obtaining radio resource status information from one or more wireless devices, wherein the radio resource status information comprises channel occupancy information (e.g., successful listen-before-talk (LBT) procedures, failed LBT procedures, etc.), and transmitting the radio resource status information to a second network node.

### TECHNICAL FIELD

Embodiments of the present disclosure are directed to wireless communications and, more particularly, to exchanging listen-before-talk (LBT) information between radio access network (RAN) nodes.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The current Third Generation Partnership Project (3GPP) fifth generation (5G) radio access network (RAN) (NG-RAN) architecture is depicted and described in TS 38.401 v 15.4.0. An example is illustrated in FIG. 1.

FIG. 1 is a block diagram illustrating an NG-RAN architecture. The NG-RAN consists of a set of gNBs connected to the 5G core (5GC) through the NG interface. An gNB can support frequency division duplex (FDD) mode, time division duplex (TDD) mode or dual mode operation. The gNBs may be interconnected through the Xn interface. A gNB may consist of a gNB-CU and gNB-DUs. A gNB-CU and a gNB-DU are connected via the F1 logical interface. By specification, one gNB-DU is connected to only one gNB-CU. However, for resiliency, a gNB-DU may be connected to multiple gNB-CUs by appropriate implementation. NG, Xn and F1 are logical interfaces.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

A gNB may also be connected to an LTE eNB via the X2 interface. Another architectural option is that where an LTE eNB connected to the Evolved Packet Core (EPC) network is connected over the X2 interface with a nr-gNB. The latter is a gNB not connected directly to a CN and connected via X2 to an eNB for the sole purpose of performing dual connectivity.

The architecture in FIG. 1 can be expanded by spitting the gNB-CU into two entities: One gNB-CU-UP, which serves the user plane and hosts the Packet Data Convergence Protocol (PDCP) and one gNB-CU-CP, which serves the control plane and hosts the PDCP and Radio Resource Control (RRC) protocol. A gNB-CU-CP and a gNB-CU-UP communicate over the E1 interface. A gNB-DU hosts the radio link control (RLC), medium access control (MAC) and physical layer (PHY) protocols.

5G new radio (NR) is developed for maximum flexibility to support multiple and substantially different use cases. Besides the typical mobile broadband use case, NR also supports machine type communication (MTC), ultra-reliable low-latency communication (URLLC), side-link device-to-device (D2D) and several other use cases.

In NR, the basic scheduling unit is referred to as a slot. A slot consists of 14 orthogonal frequency division multiplexing (OFDM) symbols for the normal cyclic prefix configuration. NR supports many different subcarrier spacing configurations and at a subcarrier spacing of 30 kHz the OFDM symbol duration is ˜33 μs. As an example, a slot with 14 symbols for the same subcarrier spacing (SCS) is 500 μs long (including cyclic prefixes).

NR also supports flexible bandwidth configurations for different UEs on the same serving cell. In other words, the bandwidth monitored by a UE and used for its control and data channels may be smaller than the carrier bandwidth. One or multiple bandwidth part (BWP) configurations for each component carrier can be semi-statically signaled to a UE, where a bandwidth part consists of a group of contiguous physical resource blocks (PRBs). Reserved resources can be configured within the bandwidth part. The bandwidth of a bandwidth part equals to or is smaller than the maximal bandwidth capability supported by a UE.

NR is targeting both licensed and unlicensed spectrum bands. Allowing unlicensed networks, i.e., networks that operate in shared spectrum (i.e., unlicensed spectrum) to effectively use the available spectrum is an attractive approach to increase system capacity. Although unlicensed spectrum does not match the qualities of the licensed regime, solutions that facilitate an efficient use of unlicensed spectrum as a complement to licensed deployments have the potential to bring value to the 3GPP operators, and, ultimately, to the 3GPP industry as a whole. Some NR features are adapted in NR-U to comply with the special characteristics of the unlicensed band as well as different regulations. The technology primarily targets subcarrier spacings of 15 kHz or 30 kHz in carrier frequencies below 6 GHz.

When operating in unlicensed spectrum, many regions in the world require a device to sense the medium to check that it is free before transmitting, This operation is often referred to as listen-before-talk (LBT), while a more formal term is clear channel assessment (CCA). There are many different flavors of LBT, depending on which radio technology the device uses and which type of data the device wants to transmit at the moment. Common for all flavors is that the sensing is done in a particular channel (corresponding to a defined carrier frequency) and over a predefined bandwidth. For example, in the 5 GHz band, the sensing is done over 20 MHz channels and this is also the sensing bandwidth used in NR-U (where such 20 MHz bandwidths/channels are often referred to as bandwidth parts (BWPs), when the full NR-U operating bandwidth is greater than 20 MHz).

Many devices are capable of transmitting (and receiving) over a wide bandwidth including use of multiple sub-bands/channels, e.g., multiple LBT sub-bands (i.e., the frequency part with a bandwidth equal to LBT bandwidth). A device is only allowed to transmit on the sub-bands (i.e. 20 MHz BWPs) where the medium is sensed as free. Again, there are different flavors of how the sensing should be done when multiple sub-bands are involved.

In principle, there are two ways a device can operate over multiple sub-bands. One way is that the transmitter/receiver bandwidth is changed depending on which sub-bands were sensed as free. In this setup, there is only one component carrier (CC) and the multiple sub-bands are treated as a single channel with a larger bandwidth. The other way is that the device operates almost independent processing chains for each channel. Depending on how independent the processing chains are, this option may be referred to as either carrier aggregation (CA) or dual connectivity (DC).

Listen-before-talk (LBT) is designed for unlicensed spectrum co-existence with other radio access technologies (RATs) (as well as independent systems with the same RAT). In this mechanism, a radio device applies a clear channel assessment (CCA) check (i.e., channel sensing) before transmission. The transmitter involves energy detection (ED) over a time period compared to a certain threshold (ED threshold) to determine if a channel is idle.

LBT parameter settings (including ED threshold) may be set for devices in a network by a network node configuring the devices in the network. The limits may be set as pre-defined rules or tables in specifications or regulatory requirements for operation in a certain region.

Such limits are part of the European Telecommunications Standards Institute (ETSI) harmonized standard in Europe as well as the 3GPP specification for operation of LTE-LAA/NR-U in unlicensed spectrum.

Further, two modes of access operations are defined—Frame-Based Equipment (FBE) and Load-Based Equipment (LBE). In FBE mode, the sensing period is simple, while the sensing scheme in LBE mode is more complex.

The default LBT mechanism for LBE operation, LBT category 4, is similar to existing Wi-Fi operation, where a node can sense the channel at any time and start transmitting if the channel is free after a deferral and backoff period. For specific cases, e.g. shared channel occupancy time (COT), other LBT categories specify a short sensing period.

Sensing is done typically for a random number of sensing intervals with this random number being a number within the range of 0 to CW, where CW represents a contention window size. Initially, a backoff counter is initialized to this random number drawn within 0 and CW. When a busy carrier is sensed to have become idle, a device must wait for a fixed period, also known as a prioritization period, after which it can sense the carrier in units of the sensing interval.

For each sensing interval within which the carrier is sensed to be idle, the backoff counter is decremented. When the backoff counter reaches zero, the device can transmit on the carrier. After transmission, if a collision is detected via the reception of a negative acknowledgement or by some other means, the contention window size, CW, is doubled.

After the transmitter has grasped access to a channel, the transmitter is only allowed to perform transmission up to a maximum time duration (namely, the maximum channel occupancy time (MCOT)). For quality of service (QoS) differentiation, a channel access priority based on the service type has been defined. For example, there are four LBT priority classes defined for differentiation of contention window sizes (CWS) and MCOT between services In FBE mode, as defined in 3GPP and illustrated in FIG. 2, the gNB assigns fixed frame periods (FFP)s, senses the channel for 9 μs just before the FFP boundary, and if the channel is sensed to be free, it starts with a downlink transmission, and/or allocates resources among different UEs in the FFP. This procedure can be repeated with a certain periodicity. In the FFP, downlink/uplink transmissions are only allowed within the COT, a subset of FFP resource, where the remaining Idle period is reserved so that other nodes also have the chance to sense and utilize the channel. Thus in FBE operations, the channel is sensed at specific intervals just before the FFP boundary. The FFP can be set to values between 1 and 10 ms and can be changed after a minimum of 200 ms. The IDLE period is a regulatory requirement and is supposed to be at least T_{IDLE}≥max(0.05*COT, 100 μs). In 3GPP TS 37.213 this has been simplified to be T_{IDLE}≥max(0.05*FFP, 100 μs), i.e. the maximum channel occupancy time, MCOT, would be defined as T_{MCOT}=min(0.95*FFP, FFP−0.1 ms). So for 10 ms FFP, the MCOT would be 9.5 ms, while for 1 ms FFP the MCOT would be 0.9 ms=0.9*FFP.

In mobile networks, the load of a radio access node and its cells is constantly measured so that when it gets above a pre-configure threshold, procedures can be triggered so that part of this load is transferred to either a neighbor cell/node of the same radio access technology (RAT) or another RAT or carrier frequency.

The set of procedures to support this transfer is referred to as mobility load balancing (MLB). Currently, 3GPP specifies the following components for the MLB solution: (a) load reporting; (b) load balancing action based on handovers (HO)s; and (c) adapting HO/cell reselection configuration so that the load remains balanced.

For Long Term Evolution (LTE), the load reporting function is executed by exchanging cell specific load information between neighbor eNodeBs (eNBs) over the X2 (intra-LTE scenario) or S1 (inter-RAT or intra-LTE without X2 scenario) interfaces. For intra-LTE load balancing, the source eNB may trigger a RESOURCE STATUS REQUEST X2AP message to potential target eNBs at any point in time, for example, when the load is above a pre-defined value. e.g., Lte_load_threshold, as shown in FIG. 3. Upon successful configuration of resource status reporting in the target eNB (involving a RESOURCE STATUS RESPONSE message), the target eNB can send (periodically or not) load/resource information in one or more RESOURCE STATUS UPDATE message(s) containing information about load per cell in the target eNB. The message exchange is highlighted in FIG. 4 (where the RESOURCE STATUS RESPONSE message is omitted) and FIG. 5.

A mobility load balancing algorithm running at a radio access node (for example, an eNB) has to decide which UE's will be handed over (a process referred to as UE selection) and to which neighbor cells (a process referred to as cell selection). These decisions are typically taken based mainly on the load reports (e.g., the information in RESOURCE STATUS UPDATE messages) and potentially available radio measurements of source cell and neighbor cells reported by the UE candidates. More details about UE/cell selection processes are described below.

In other words, the UE may send measurement reports (reference signal receive power (RSRP), reference signal receive quality (RSRQ), signal to interference and noise ratio (SINR), etc.) for a given neighbor cell (e.g., cell-2 in eNB-2) and, upon the reception of these and having load information of such neighbor cell, the source eNB may decide to handover a UE to the neighbor cell due to overload. In this case, a handover preparation is triggered towards a target node, e.g. eNB-2.

As part of the resource status reporting procedure, a first eNB sending load information to a second eNB can include an indication (such as Cell Reporting Indicator) to indicate to the second eNB node that the ongoing transfer of load information has to be stopped. This may be used, e.g., as an indication that the load in the first eNB has become excessive.

Another procedure that may be executed is a mobility setting change procedure. The mobility setting change procedure can be run before or after a MLB handover is performed. This procedure negotiates between the source eNB and potential target eNB a change of the handover trigger event, which is used to trigger the mobility event from a certain cell controlled by the source eNB to a certain cell controlled by the target eNB.

As an example, consider the case where the mobility setting change procedure is performed after the HO. Once the source eNB has selected the target eNB and which UEs will be offloaded, it performs a mobility setting change procedure (also specified by 3GPP [TS 36.423]). During this procedure, new mobility settings are negotiated between the source and target eNBs so that UEs handed over to a new (target) cell due to load balancing (i.e., to offload the source cell that is overloaded or at risk of becoming overloaded) will not be immediately handed over back to the old cell. The procedure can either be followed or preceded by ordinary handovers, depending on the vendor implementation. A summary is shown in FIG. 5.

MLB in NR follows signaling principles that are in line with LTE. Similar signaling mechanisms are used in NG-RAN with a difference that the MLB metrics are reported over the split RAN interfaces. To this end, signaling support for resource status reporting has been introduced over Xn, F1 and E1, inter-node interfaces as well as enhanced over X2 for EN-DC scenario. In addition, the NG-RAN MLB functionality has been enhanced with new types of load metrics and with finer load granularity than in LTE (where load information is expressed on a per-cell basis only). In particular, the NG-RAN MLB enhancements include: (a) load information on a per SSB coverage area granularity, such as radio resource status reporting per SSB area and composite available capacity reporting per SSB Area; (b) load information on a per network slice granularity, such as slice available capacity reporting per slice; (c) hardware load indicator over E1; (d) TNL capacity indication; (e) number of active UEs; and (f) number of RRC connections.

As an example, one can consider the XnAP specification in TS 38.423 v 16.2.0, where the resource status reporting indication procedure is specified in sections 8.4.10, 8.4.11 and 9.1.3.

In the current standard, information concerning per cell load and capacity are captured in the following information elements, which are here reported with respect to the NR RAT for convenience. The following is an excerpt of TS 38.423 v 16.3.0.

The Radio Resource Status IE indicates the usage of the PRBs per cell and per SSB area for all traffic in downlink and uplink and the usage of physical downlink control channel (PDCCH) control channel elements (CCEs) for downlink and uplink scheduling.

| IE/Group Name | Presence | Range | IE type and reference | Semantics description |
|---|---|---|---|---|
| CHOICE Radio Resource Status Type | M | | | |
| >ng-eNB | | | | |
| >>DL GBR PRB usage | M | | INTEGER (0..100) | Per cell DL GBR PRB |
| | | | | usage |
| >>UL GBR PRB usage | M | | INTEGER (0..100) | Per cell UL GBR PRB |
| | | | | usage |
| >>DL non-GBR PRB usage | M | | INTEGER (0..100) | Per cell DL non-GBR PRB |
| | | | | usage |
| >>UL non-GBR PRB usage | M | | INTEGER (0..100) | Per cell UL non-GBR PRB |
| | | | | usage |
| >>DL Total PRB usage | M | | INTEGER (0..100) | Per cell DL Total PRB |
| | | | | usage |
| >>UL Total PRB usage | M | | INTEGER (0..100) | Per cell UL Total PRB |
| | | | | usage |
| >gNB | | | | |
| >>SSB Area Radio Resource Status List | | 1 | | |
| >>>SSB Area Radio Resource Status | | 1..<max | | |
| Item | | noofSSB | | |
| | | Areas> | | |
| >>>>SSB Index | M | | INTEGER (0..63) | |
| >>>>SSB Area DL GBR PRB usage | M | | INTEGER (0..100) | Per SSB area DL GBR |
| | | | | PRB usage |
| >>>>SSB Area UL GBR PRB usage | M | | INTEGER (0..100) | Per SSB area UL GBR |
| | | | | PRB usage |
| >>>>SSB Area DL non-GBR PRB | M | | INTEGER (0..100) | Per SSB area DL non-GBR |
| usage | | | | PRB usage |
| >>>>SSB Area UL non-GBR PRB | M | | INTEGER (0..100) | Per SSB area UL non-GBR |
| usage | | | | PRB usage |
| >>>>SSB Area DL Total PRB usage | M | | INTEGER (0..100) | Per SSB area DL Total |
| | | | | PRB usage |
| >>>>SSB Area UL Total PRB usage | M | | INTEGER (0..100) | Per SSB area UL Total |
| | | | | PRB usage |
| >>DL scheduling PDCCH CCE usage | O | | INTEGER (0..100) | |
| >>UL scheduling PDCCH CCE usage | O | | INTEGER (0..100) | |

| Range bound | Explanation |
|---|---|
| maxnoofSSBAreas | Maximum no. SSB Areas that can |
| | be served by a NG-RAN node cell. |
| | Value is 64. |

The Composite Available Capacity Group IE indicates the overall available resource level per cell and per SSB area in the cell in downlink and uplink.

| | | | IE type and | Semantics |
|---|---|---|---|---|
| IE/Group Name | Presence | Range | reference | description |
| Composite Available | M | | Composite | For the Downlink |
| Capacity | | | Available | |
| Downlink | | | Capacity | |
| | | | 9.2.2.52 | |
| Composite Available | M | | Composite | For the Uplink |
| Capacity Uplink | | | Available | |
| | | | Capacity | |
| | | | 9.2.2.52 | |

The Composite Available Capacity IE indicates the overall available resource level in the cell in either downlink or uplink.

| | | | IE type and | |
|---|---|---|---|---|
| IE/Group Name | Presence | Range | reference | Semantics description |
| Cell Capacity Class Value | O | | 9.2.2.53 | |
| Capacity Value | M | | 9.2.2.54 | ‘O’ indicates no resource is available, |
| | | | | Measured on a linear scale. |

The Cell Capacity Class Value IE indicates the value that classifies the cell capacity with regards to the other cells. The Cell Capacity Class Value IE only indicates resources that are configured for traffic purposes.

| | | | IE type and | |
|---|---|---|---|---|
| IE/Group Name | Presence | Range | reference | Semantics description |
| Capacity Class Value | M | | INTEGER | Value 1 indicates the minimum cell capacity, |
| | | | (1..100, . . . ) | and 100 indicates the maximum cell capacity. |
| | | | | There should be a linear relation between cell |
| | | | | capacity and Cell Capacity Class Value. |

The Capacity Value IE indicates the amount of resources per cell and per SSB area that are available relative to the total NG-RAN resources. The capacity value should be measured and reported so that the minimum NG-RAN resource usage of existing services is reserved according to implementation. The Capacity Value IE can be weighted according to the ratio of cell capacity class values, if available.

| | | | IE type and | |
|---|---|---|---|---|
| IE/Group Name | Presence | Range | reference | Semantics description |
| Capacity Value | M | | INTEGER | Value 0 indicates no available capacity, and |
| | | | (0..100) | 100 indicates maximum available capacity |
| | | | | with respect to the whole cell. Capacity Value |
| | | | | should be measured on a linear scale. |
| SSB Area Capacity Value List | | 0..1 | | |
| >SSB Area Capacity Value | | 0..<max | | |
| Item | | noofSSB | | |
| | | Areas> | | |
| >>SSB Index | M | | INTEGER | |
| | | | (0..63) | |
| >>SSB Area Capacity Value | M | | INTEGER | Value 0 indicates no available capacity, and |
| | | | (0..100) | 100 indicates maximum available capacity. |
| | | | | SSB Area Capacity Value should be |
| | | | | measured on a linear scale. |

| Range bound | Explanation |
|---|---|
| maxnoofSSBAreas | Maximum no. SSB Areas that can |
| | be served by a NG-RAN node cell. |
| | Value is 64. |

The above illustrate that the Radio Resource Status comprises a percentage measure of the PRBs that are used in a cell. This metric can be either expressed per cell, or per SSB Area. The metric can distinguish between per guaranteed bit rate (GBR) and per non-GBR bearers and it can express PDCCH resource utilization.

Similarly, the composite available capacity is represented as a measure of available capacity (the Capacity Value IE) with respect to the Cell Capacity Class Value IE, which constitutes the maximum cell capacity available.

There currently exist certain challenges. For example, the currently specified MLB functionality, in particular the load related information exchanged between RAN nodes, is specified with licensed spectrum in mind and does not take the special properties of operation in shared spectrum into account, e.g., that the utilized spectrum may be temporarily unavailable due to competition from other systems. Thus, if existing MLB mechanisms were applied in a shared spectrum scenario, this would lead to incorrect conclusions about the conditions of the neighbor RAN nodes and their cells, which in turn would lead to suboptimal MLB decisions, e.g. in terms of bad decisions (or lack of decisions) of handovers of UEs to relieve one cell of load at the expense of another cell.

Some existing solutions include new information relevant to shared spectrum operation to be exchanged between RAN nodes and new procedures for such exchange. The information includes information about the way a shared channel is deemed available or occupied and methods for exchanging between RAN nodes load information that consider shared channel occupancy and factors related to how resources are used when a channel is shared. More specifically, they describe exchange of LBT configuration parameters, including FBE/LBE, energy detection (ED) threshold and used channel access priority classes (CAPCs). Regarding load and channel occupancy information, and related information, they describe exchange of load information, LB failure rate, average/maximum channel occupancy time (i.e., the time the channel is kept for transmissions after a successful LBT procedure), duration or percentage of time during which the channel was unavailable because of LBT failure, the compound resources utilized for own-cell traffic during the time when the channel was available (for use by own-cell traffic), and the fraction of time the channel was not occupied by non-own-cell traffic.

However, although the information proposed is sufficient for basic MLB decisions, it does not include sufficient information for a deep analysis of the state and operation conditions of the neighbor RAN node and its cells. More thorough analysis is beneficial and may lead to more optimized MLB decisions and actions, but this requires more information and details about the conditions and operational details of the neighbor RAN node and its cells as input to the deeper analysis, especially so when the extent to which RAN functionality is controlled and optimized by artificial intelligence (AI)/machine language (ML) based algorithms increases.

### SUMMARY

Based on the description above, certain challenges currently exist with mobility load balancing (MLB) for unlicensed spectrum. Certain aspects of the present disclosure and their embodiments may provide solutions to these or other challenges. Particular embodiments include additional types of information to be exchanged between radio access network (RAN) nodes operating in shared spectrum, complementing the information described above. In particular embodiments, the information includes further details, in particular related to listen-before-talk (LBT) procedures, that enables the receiver of the information (e.g., the receiving RAN node) to perform deeper analysis and achieve a better understanding of the conditions in the cell(s) of the RAN node transmitting the information, thereby potentially enabling more well-founded and optimized MLB related decisions.

In general, particular embodiments exchange, between RAN nodes, information about load and in particular information related to LBT procedures and LBT configuration, for providing a view on the conditions in the cell which the information pertains to, e.g., to facilitate and optimize MLB related decisions and actions.

According to some embodiments, a method performed by a first network node operating in shared spectrum comprises obtaining radio resource status information from one or more wireless devices. The radio resource status information comprises channel occupancy information. The method further comprises transmitting the radio resource status information to a second network node.

According to some embodiments, a method performed by a second network node operating in shared spectrum comprises receiving radio resource status information from a first network node. The radio resource status information comprises channel occupancy information for one or more wireless devices associated with the first network node. The method further comprises performing a MLB operation based on the radio resource status information.

In particular embodiments, the radio resource status information comprises one or more of: an indication of a number of successful LBT procedures; an indication of a number of failed LBT procedures; an indication of a total time spent monitoring a channel during LBT procedures; an indication of an average time spent monitoring a channel during LBT procedures; an indication of an average number of idle monitoring intervals that precede a transmission; an indication of a contention window size used for an LBT procedure; an indication of a defer duration used for an LBT procedure; an indication of a value of a counter that determines a number of idle sensing periods that precede a transmission; an indication of a number of occurrences of shared channel occupancy time (COT); an indication of a total duration of shared COT occurrences; an indication of average duration of a shared COT occurrence; an indication of an average detected energy during failed LBT procedures; an indication of an average detected energy during successful LBT procedures; an indication of an average difference between an energy detection (ED) threshold and detected energy for failed LBT procedures; and/or an indication of an average delay of transmissions for which a first LBT procedure failed.

In particular embodiments, the radio resource status information is related to only downlink, only uplink, or both uplink and downlink. The radio resource status information may be separated by any one or more of channel access priority class, traffic type, physical channel, transport channel, and logical channel. The radio resource status information may exclude information for LBT procedures preceding synchronization signal block (SSB) transmissions.

According to some embodiments, a network node comprises processing circuitry operable to perform any of the network node methods described above.

A computer program product comprises a non-transitory computer readable medium storing computer readable program code, the computer readable program code operable, when executed by processing circuitry to perform any of the methods performed by the network nodes described above.

Certain embodiments may provide one or more of the following technical advantages. For example, particular embodiments include enhanced analysis to obtain a deeper understanding of the conditions in neighbor RAN node cells, thereby facilitated more well-founded and optimized MLB decisions and actions, e.g., in terms of handover decisions as well as selection of user equipment (UEs) to be handed over.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating an NG-RAN architecture;

FIG. 2 is a timing diagram illustrating an example frame based equipment (FBE) procedure using 3GPP semi-static channel occupancy;

FIG. 3 is a graph illustrating on overload scenario triggering mobility load balancing (MLB) procedures;

FIG. 4 is a flowchart illustrating X2 load information exchange procedures for MLB;

FIG. 5 is a flow diagram illustrating MLB execution, including a mobility setting change procedure;

FIG. 6 is a block diagram illustrating an example wireless network;

FIG. 7 illustrates an example user equipment, according to certain embodiments;

FIG. 8 is flowchart illustrating an example method in a network node, according to certain embodiments;

FIG. 9 is a flowchart illustrating another example method in a network node, according to certain embodiments;

FIG. 10 illustrates a schematic block diagram of a wireless device and network node in a wireless network, according to certain embodiments;

FIG. 11 illustrates an example virtualization environment, according to certain embodiments;

FIG. 12 illustrates an example telecommunication network connected via an intermediate network to a host computer, according to certain embodiments;

FIG. 13 illustrates an example host computer communicating via a base station with a user equipment over a partially wireless connection, according to certain embodiments;

FIG. 14 is a flowchart illustrating a method implemented, according to certain embodiments;

FIG. 15 is a flowchart illustrating a method implemented in a communication system, according to certain embodiments;

FIG. 16 is a flowchart illustrating a method implemented in a communication system, according to certain embodiments; and

FIG. 17 is a flowchart illustrating a method implemented in a communication system, according to certain embodiments.

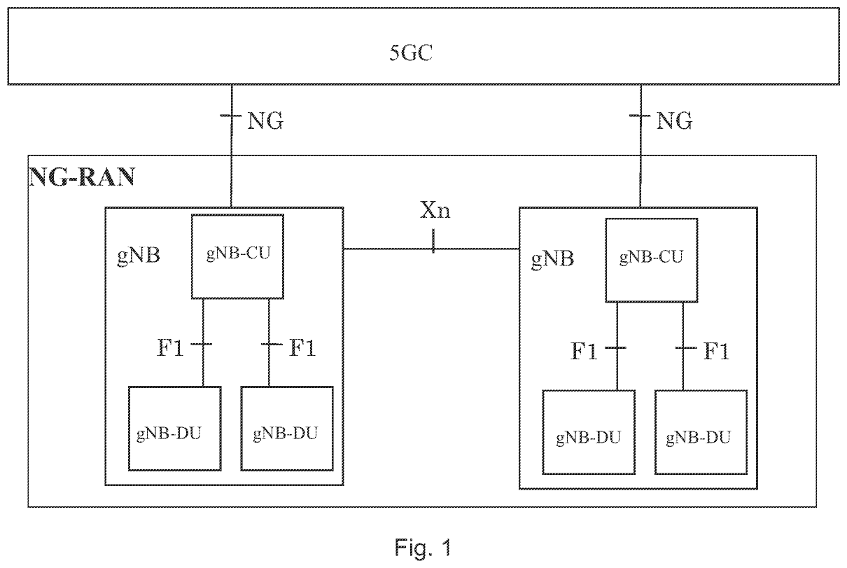

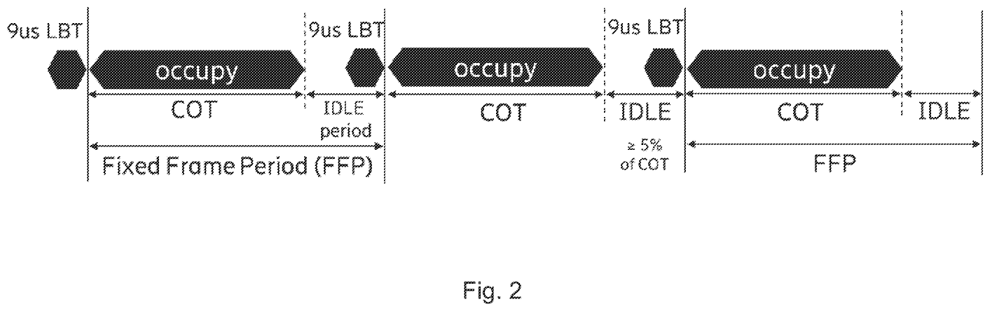

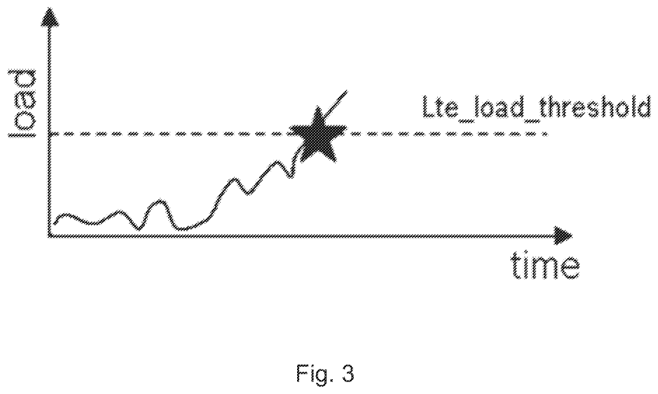

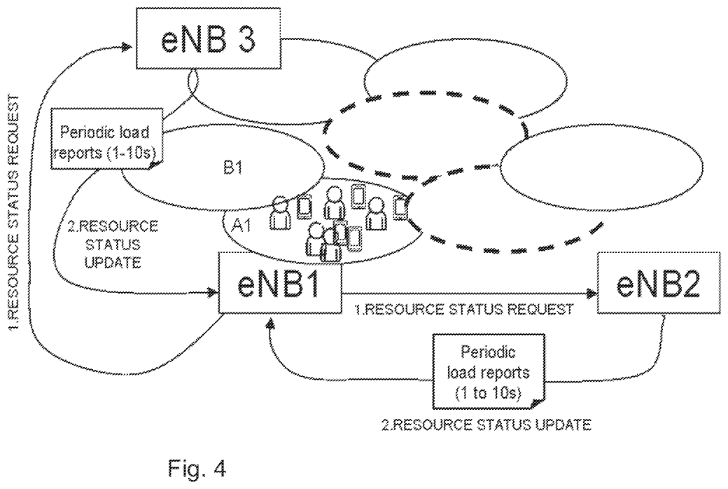

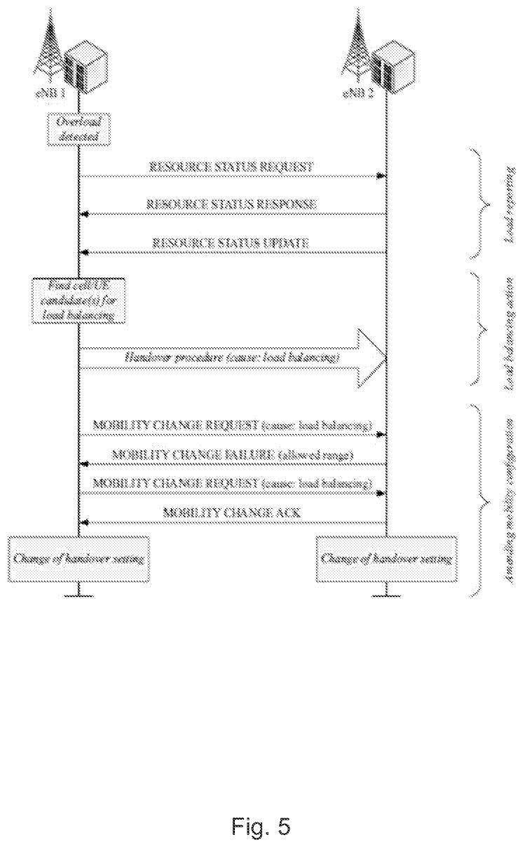

### DETAILED DESCRIPTION

As described above, certain challenges currently exist with mobility load balancing (MLB) for unlicensed spectrum. Certain aspects of the present disclosure and their embodiments may provide solutions to these or other challenges. Particular embodiments include additional types of information to be exchanged between radio access network (RAN) nodes operating in shared spectrum, such as information related to listen-before-talk (LBT) procedures, that enable the receiver of the information (e.g., the receiving RAN node) to perform deeper analysis and achieve a better understanding of the conditions in the cell(s) of the RAN node transmitting the information, thereby potentially enabling more well-founded and optimized MLB related decisions.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Particular embodiments address the above described problems by including additional types of information to be exchanged between RAN nodes operating in shared spectrum. For example, a RAN node, e.g. a gNB or an eNB, may send to a neighbor RAN node (e.g., using a RESOURCE STATUS UPDATE XnAP or X2AP message), e.g. a gNB or an eNB, over the Xn or X2 interface or via the core network over the NG or S1 interface, unsolicited or on request from the neighbor RAN node, e.g. for the purpose of supporting MLB operations, one or more of the following information items related to a particular time period (e.g., collected, measured, counted or otherwise obtained during the time period).

The information may comprise total available resources. This is the sum of the unused resources while the channel(s) was/were not occupied by non-own-cell traffic (i.e., the sum of the full bandwidth resources during the time periods when no node or device used the channel(s) and the unused resources during the time periods when the channel(s) was/were used for own-cell traffic).

The information may comprise successful LBT procedures. This may be divided into successful LBT procedures per channel access priority class (CAPC). For example, the RAN node may compute the number of successful LBT operations, i.e., physical layer sensing the channel free, measured within a period of time in a given cell. In another alternative, the RAN node computes within a period of time in a given cell, the ratio between the number of successful LBT procedures over the number of times the RAN node has scheduled a packet for transmission in a scheduling occasion within the period of time.

The information may comprise failed LBT operations. This may be divided into failed LBT procedures per CAPC. For example, the RAN node may compute the number of failed LBT operations, i.e. physical layer sensing the channel busy, measured within a period of time in a given cell. In another alternative, the RAN node computes within a period of time in a given cell, the ratio between the number of failed LBT operations over the number of times the RAN node has scheduled a packet for transmission in a scheduling occasion within the period of time.

The information may comprise total time spent monitoring/sensing the (potential occupancy of the) channel (e.g., measuring the received energy) during LBT procedures.

The information may comprise the average channel monitoring/sensing time for an LBT procedure.

The information may comprise the average number of idle sensing intervals that have to precede a transmission (e.g., in the dynamic channel access procedure).

The information may comprise the fraction, e.g. percentage, of the LBT procedures that used the LBT procedure configurations associated with respectively CAPC 1, CAPC 2, CAPC 3 and CAPC 4.

The information may comprise further information about the LBT configuration(s), e.g., information about the LBT related configuration parameters, such as: (a) the contention window(s) (CW) in use during the LBT procedures, e.g. size(s) or average size; (b) the contention window(s) in use per priority class (e.g., per CAPC) (CWₚ) during the LBT procedures, e.g., size(s) or average size; (c) the defer duration(s) (T_{d}) used in the LBT procedures; and/or the initial value, Nᵢₙᵢₜ, of the counter that determines the number of idle sensing periods that have to precede a transmission (in the dynamic channel access procedure).

The information may comprise information related to shared COT, such as: (a) the number of occurrences of shared COT; (b) the total duration of the shared COT occurrences; and/or (c) the average duration of a shared COT occurrence.

The information may comprise the average detected energy during failed LBT procedures. This may be indicated as received signal strength indicator (RSSI), as an energy measure (e.g., measured in Joule), or as a power measure (e.g., the average power during the monitoring/sensing periods). To the receiver of the information, this information may indicate, e.g., if an increase of the energy detection (ED) threshold would result in significantly increased number of successful LBT procedures (or, conversely, a significantly reduced number of failed LBT procedures). This could beneficially be combined with information with regards to the utilized ED threshold(s). This may be extended/complemented with additional related statistical measures, such as the variance or standard deviation of the distribution of the average detected energy during failed LBT procedures.

The information may comprise the average detected energy during successful LBT procedures. This may be indicated as RSSI, as an energy measure (e.g., measured in Joule), or as a power measure (e.g., the average power during the monitoring/sensing periods). To the receiver of the information, this information may indicate, e.g., if a decrease of the ED threshold would result in significantly increased number of failed LBT procedures (or, conversely, a significantly reduced number of successful LBT procedures). This could beneficially be combined with information with regards to the utilized ED threshold(s). This may be extended/complemented with additional related statistical measures, such as the variance or standard deviation of the distribution of the average detected energy during successful LBT procedures.

The information may comprise the average difference between the detected energy and the ED threshold for failed LBT procedures. This may be indicated, e.g., as an energy measure (e.g., measured in Joule) or as a ratio or in terms of dB. To the receiver of the information, this information may indicate, e.g., if an increase of the ED threshold would result in significantly increased number of successful LBT procedures (or, conversely, a significantly reduced number of failed LBT procedures). This could beneficially be combined with information with regards to the utilized ED threshold(s). This may be extended/complemented with additional related statistical measures, such as the variance or standard deviation of the distribution of the difference between the detected energy and the ED threshold for failed LBT procedures.

The information may comprise the average difference between the ED threshold and the detected energy for failed LBT procedures. This may be indicated, e.g., as an energy measure (e.g., measured in Joule) or as a ratio or in terms of dB. To the receiver of the information, this information may indicate, e.g., if a decrease of the ED threshold would result in significantly increased number of failed LBT procedures (or, conversely, a significantly reduced number of successful LBT procedures). This could beneficially be combined with information with regards to the utilized ED threshold(s). This may be extended/complemented with additional related statistical measures, such as the variance or standard deviation of the distribution of the difference between the ED threshold and the detected energy for failed LBT procedures.

The information may comprise the average delay of a transmission for which the first LBT procedure failed, and/or other information related to these delays. To the receiver of this information, this can provide information about the time pattern (if any) of the detected channel occupancy, e.g., if is bursty with many very short periods of channel occupancy or appears in longer continuous blocks. (Note that here “continuous” does not have to mean that the channel occupancy was completely without gaps, but that the gaps, if they existed, were so short that they were not discovered by the reporting system (e.g., because neither the reporting RAN node nor any of its UEs performed LBT during the gaps.) This may be extended/complemented with additional related statistical measures, such as the variance or standard deviation of the distribution of delays of transmissions for which the first LBT procedure failed.

The above information items may be reported related only to the downlink, related only to the uplink (for which the RAN node may obtain LBT related information, such as statistics on successes and failures, delays and/or detected energy, from the UEs served in the concerned cell), both related to the downlink and related to the uplink, or reflecting the compound metrics, measures or measurement quantities for the downlink and the uplink combined.

In some embodiments, any of the above information items may be reported/divided into categories, e.g. per traffic type (e.g., URLLC, delay sensitive, delay insensitive, critical, non-critical, low, medium and high priority, V2X traffic, MTC, etc.), per service type (e.g., streaming (e.g., audio or video streaming), MTSI, web browsing, VR, AR, per QoS class, per network slice, etc. Note that these ways of dividing the information may also be combined in various ways, e.g., dividing it per traffic type per network slice.

In some embodiments, information related to SSB transmissions, such as statistics on the LBT procedures preceding intended SSB transmissions, may be treated differently than, e.g. separately from, the corresponding information related to other types of transmissions.

Optionally, the information related to SSB transmissions may even be excluded from the information exchanged between RAN nodes, e.g. excluding LBTs preceding intended SSB transmissions from the exchanged LBT statistics.

In some embodiments, the exchanged information may be divided per physical channel, transport channel or logical channel (or logical channel group) it is related to (e.g., the channel the transmission intended to follow an LBT procedure is planned to be sent on), e.g. the PDCCH, PDSCH, PBCH, etc., or the DL-SCH, PCH, BCH, etc., or the PUCCH, PUSCH, etc., or the BCCH, PCCH, CCCH, DCCH, DTCH, etc.

In some embodiments, the exchanged information may be divided into SSB related information as one category together with any of the above mentioned divisions into NR (or LTE) channel categories.

A RAN node (e.g., a gNB or an eNB) receiving any of the previously described information items that may be transmitted from one RAN node to another, may use at least part of the received information in one or more methods or functions, e.g., adapting LBT configuration(s), selecting UEs for MLB handover(s), triggering MLB handover(s) (e.g., to the RAN node from which the information was received), and/or accepting MLB handover request(s) from the RAN node from which the information was received.

The RAN node receiving any of the previously described information items may, for example, determine how much the LBT failures affect the performances in the neighboring RAN node transmitting the information, e.g., by comparing the number of successful LBT operations and the number of unsuccessful LBT operations, or the ratio between successful and unsuccessful LBT operations. This information about the LBT may be used to weigh the PRB usage information received in the Radio Resource Status. For example, the PRB usage may be low in some cases, but the number of LBT failures may be high. Based on the relationship between PRB usage and LBT failures/successes (e.g., PRB usage below a threshold and LBT failures below a threshold), the RAN node may determine that load balancing towards the neighboring RAN node that sent the information may be performed for some users.

Furthermore, a RAN node receiving any of the previously described information items that may be transmitted from one RAN node to another may feed at least part of the received information into one or more AI/ML entities or AI/ML algorithms, wherein, as one option, the concerned AI/ML entity(entities) or AI/ML algorithm(s) may be involved in decisions of improvements of any of the mentioned methods or functions.

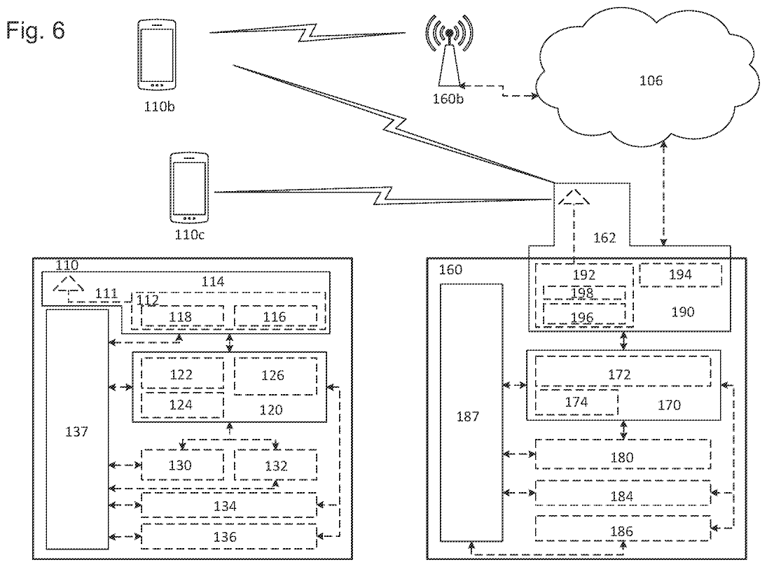

FIG. 6 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 160 includes processing circuitry 170, device readable medium 180, interface 190, auxiliary equipment 184, power source 186, power circuitry 187, and antenna 162. Although network node 160 illustrated in the example wireless network of FIG. 6 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 6 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

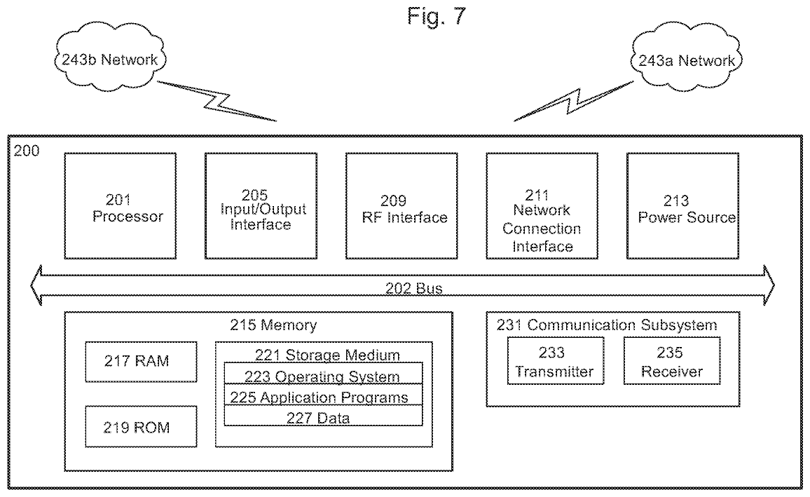

FIG. 7 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 7, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may use all the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 7, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

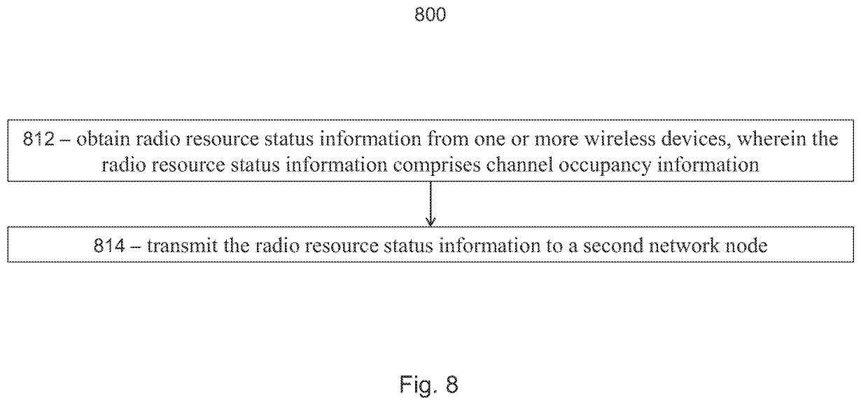

FIG. 8 is a flowchart illustrating an example method in network node, according to certain embodiments. In particular embodiments, one or more steps of FIG. 8 may be performed by network node 160 described with respect to FIG. 6. The network node is operating in shared spectrum.

The method begins at step 812, where the network node (e.g., network node 160) obtains radio resource status information from one or more wireless devices. The radio resource status information comprises channel occupancy information.

In particular embodiments, the radio resource status information comprises one or more of: an indication of a number of successful LBT procedures; an indication of a number of failed LBT procedures; an indication of a total time spent monitoring a channel during LBT procedures; an indication of an average time spent monitoring a channel during LBT procedures; an indication of an average number of idle monitoring intervals that precede a transmission; an indication of a contention window size used for an LBT procedure; an indication of a defer duration used for an LBT procedure; an indication of a value of a counter that determines a number of idle sensing periods that precede a transmission; an indication of a number of occurrences of shared channel occupancy time (COT); an indication of a total duration of shared COT occurrences; an indication of average duration of a shared COT occurrence; an indication of an average detected energy during failed LBT procedures; an indication of an average detected energy during successful LBT procedures; an indication of an average difference between an energy detection (ED) threshold and detected energy for failed LBT procedures; and/or an indication of an average delay of transmissions for which a first LBT procedure failed. The radio resource status information may comprise any of the information described with respect to the embodiments and examples above.

In particular embodiments, the radio resource status information is related to only downlink, only uplink, or both uplink and downlink. The radio resource status information may be separated by any one or more of channel access priority class, traffic type, physical channel, transport channel, and logical channel. The radio resource status information may exclude information for LBT procedures preceding synchronization signal block (SSB) transmissions.

At step 814, the network node transmits the radio resource status information to a second network node. The second network node may use the radio resource status information for a MLB procedure.

Modifications, additions, or omissions may be made to method 800 of FIG. 8. Additionally, one or more steps in the method of FIG. 8 may be performed in parallel or in any suitable order.

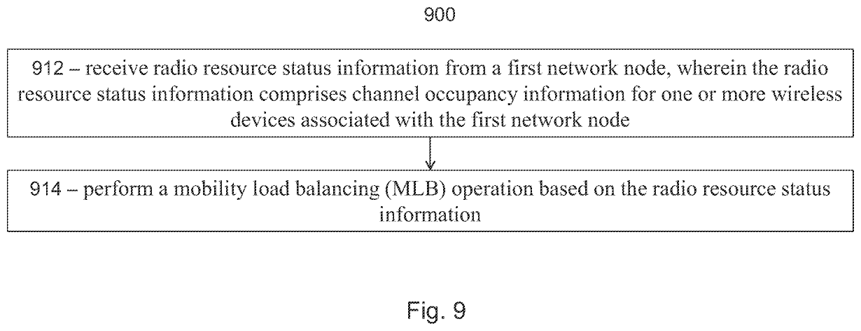

FIG. 9 is a flowchart illustrating another example method in a network node, according to certain embodiments. In particular embodiments, one or more steps of FIG. 9 may be performed by network node 160 described with respect to FIG. 6. The network node is operating in shared spectrum.

The method begins at step 912, where the network node (e.g., network node 160) receives radio resource status information from a first network node. The radio resource status information comprises channel occupancy information for one or more wireless devices associated with the first network node. The radio resource status information may comprise any of the information described with respect to the embodiments and examples above.

At step 914, the network node performs a MLB operation based on the radio resource status information. The MLB operation may comprise any of the MLB operations described in the embodiments and examples above.

Modifications, additions, or omissions may be made to method 900 of FIG. 9. Additionally, one or more steps in the method of FIG. 9 may be performed in parallel or in any suitable order.

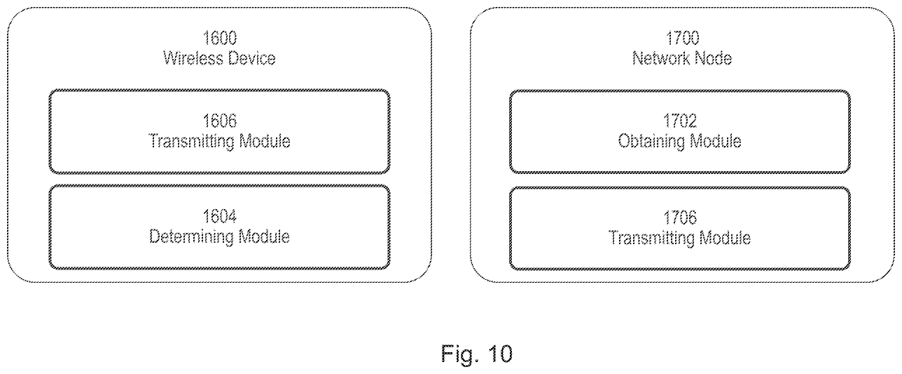

FIG. 10 illustrates a schematic block diagram of two apparatuses in a wireless network (for example, the wireless network illustrated in FIG. 6). The apparatuses include a wireless device and a network node (e.g., wireless device 110 and network node 160 illustrated in FIG. 6). Apparatus 1700 is operable to carry out the example methods described with reference to FIGS. 8 and 9, and possibly any other processes or methods disclosed herein. It is also to be understood that the methods of FIGS. 8 and 9 are not necessarily carried out solely by apparatus 1700. At least some operations of the methods may be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause transmitting module 1606, determining module 1604, and any other suitable units of apparatus 1600 to perform corresponding functions according one or more embodiments of the present disclosure. Similarly, the processing circuitry described above may be used to cause obtaining module 1702, transmitting module 1706, and any other suitable units of apparatus 1700 to perform corresponding functions according one or more embodiments of the present disclosure.

As illustrated in FIG. 10, apparatus 1600 includes transmitting module 1606 configured to transmit radio resource status information to a network node according to any of the embodiments and examples described herein.

As illustrated in FIG. 10, apparatus 1700 includes obtaining module 1702 configured to obtain radio resource status information from a wireless device according to any of the embodiments and examples described herein. Transmitting module 1706 is configured to transmit radio resource status information to another network node according to any of the embodiments and examples described herein.

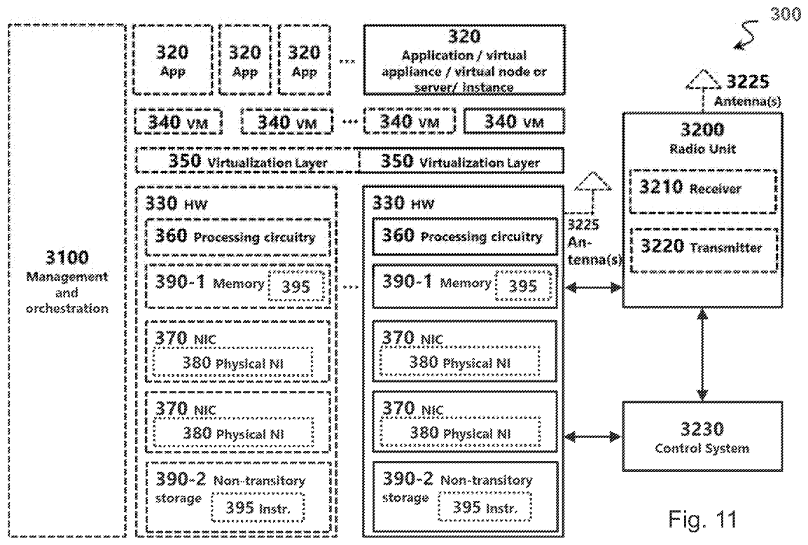

FIG. 11 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 11, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

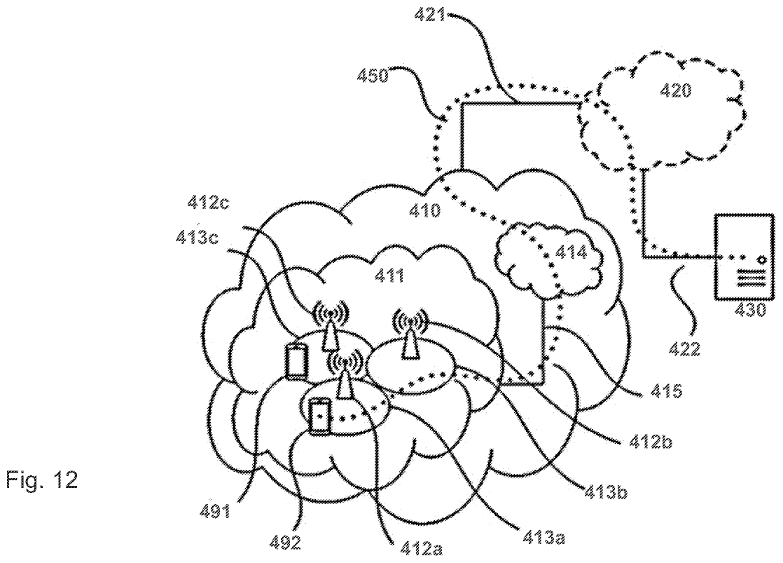

With reference to FIG. 12, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 12 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

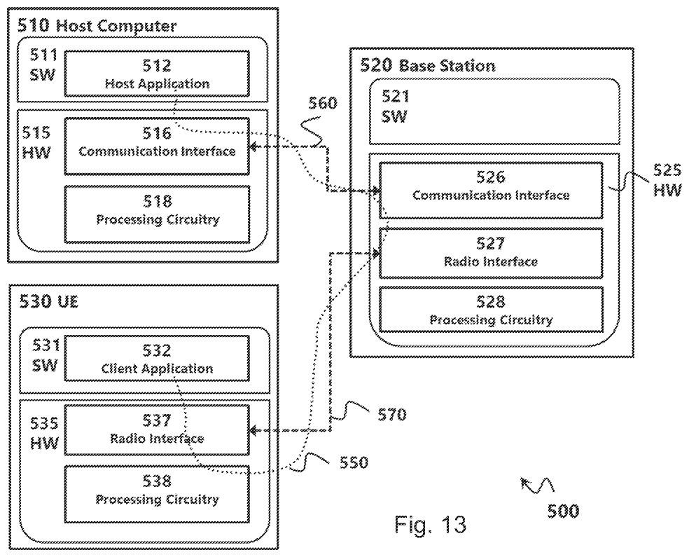

FIG. 13 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 13. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 13) served by base station 520. Communication interface 526 may be configured to facilitate connection 560 to host computer 510. Connection 560 may be direct, or it may pass through a core network (not shown in FIG. 13) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 13 may be similar or identical to host computer 430, one of base stations 412a, 412b, 412c and one of UEs 491, 492 of FIG. 6, respectively. This is to say, the inner workings of these entities may be as shown in FIG. 13 and independently, the surrounding network topology may be that of FIG. 6.

In FIG. 13, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, and thereby provide benefits such as reduced user waiting time, better responsiveness and extended battery life.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

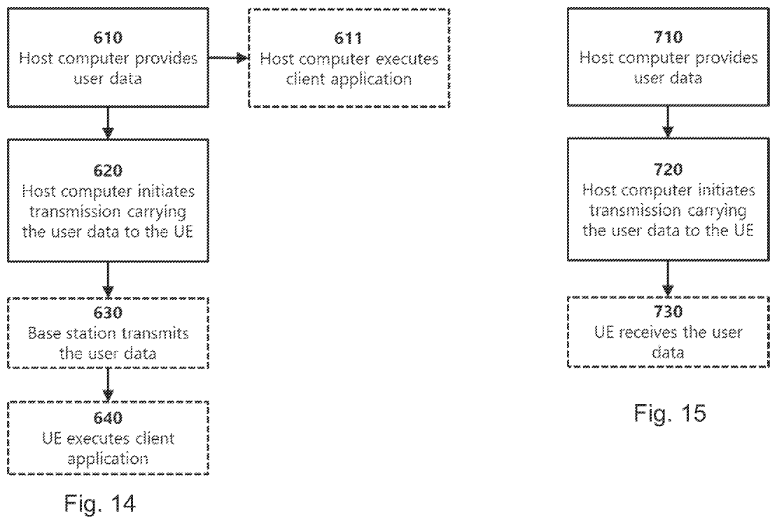

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

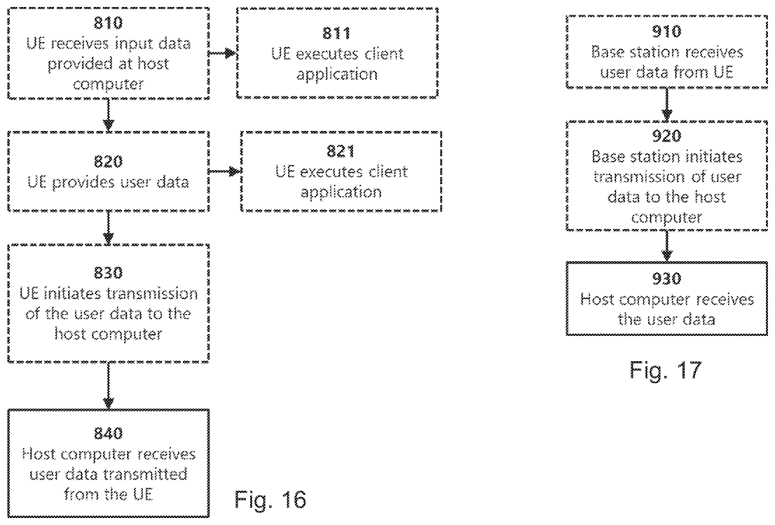

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a first network node operating in shared spectrum, the method comprising:
obtaining radio resource status information from one or more wireless devices, wherein the radio resource status information comprises channel occupancy information; and
transmitting the radio resource status information to a second network node.

2. The method of claim 1, wherein the radio resource status information comprises one or more of:
an indication of a number of successful listen-before-talk (LBT) procedures; and
an indication of a number of failed LBT procedures.

3. The method of claim 1, wherein the radio resource status information comprises one or more of an indication of a total time spent monitoring a channel during LBT procedures;
an indication of an average time spent monitoring a channel during LBT procedures; and
an indication of an average number of idle monitoring intervals that precede a transmission.

4. The method of claim 1, wherein the radio resource status information comprises one or more of:
an indication of a contention window size used for an LBT procedure;
an indication of a defer duration used for an LBT procedure; and
an indication of a value of a counter that determines a number of idle sensing periods that precede a transmission.

5. The method of claim 1, wherein the radio resource status information comprises one or more of:
an indication of a number of occurrences of shared channel occupancy time (COT);
an indication of a total duration of shared COT occurrences; and
an indication of average duration of a shared COT occurrence.

6.-10. (canceled)

11. A first network node capable of operating in shared spectrum, the first network node comprising processing circuitry operable to:
obtain radio resource status information from one or more wireless devices, wherein the radio resource status information comprises channel occupancy information; and
transmit the radio resource status information to a second network node.

12. The first network node of claim 11, wherein the radio resource status information comprises one or more of:
an indication of a number of successful listen-before-talk (LBT) procedures; and
an indication of a number of failed LBT procedures.

13. The first network node of claim 11, wherein the radio resource status information comprises one or more of:
an indication of a total time spent monitoring a channel during LBT procedures;
an indication of an average time spent monitoring a channel during LBT procedures; and
an indication of an average number of idle monitoring intervals that precede a transmission.

14. The first network node of claim 11, wherein the radio resource status information comprises one or more of:
an indication of a contention window size used for an LBT procedure;
an indication of a defer duration used for an LBT procedure; and
an indication of a value of a counter that determines a number of idle sensing periods that precede a transmission.

15. The first network node of claim 11, wherein the radio resource status information comprises one or more of:
an indication of a number of occurrences of shared channel occupancy time (COT);
an indication of a total duration of shared COT occurrences; and
an indication of average duration of a shared COT occurrence.

16. The first network node of claim 11L wherein the radio resource status information comprises one or more of:
an indication of an average detected energy during failed LBT procedures;
an indication of an average detected energy during successful LBT procedures; and
an indication of an average difference between an energy detection (ED) threshold and detected energy for failed LBT procedures.

17. The first network node of claim 11, wherein the radio resource status information comprises an indication of an average delay of transmissions for which a first LBT procedure failed.

18. The first network node of claim 11, wherein the radio resource status information is related to only downlink, only uplink, or both uplink and downlink.

19. The first network node of claim 11, wherein the radio resource status information is separated by any one or more of channel access priority class, traffic type, physical channel, transport channel, and logical channel.

20. The first network node of claim 11, wherein the radio resource status information excludes information for LBT procedures preceding synchronization signal block (SSB) transmissions.

21. A method performed by a second network node operating in shared spectrum, the method comprising:
receiving radio resource status information from a first network node, wherein the radio resource status information comprises channel occupancy information for one or more wireless devices associated with the first network node; and
performing a mobility load balancing (MLB) operation based on the radio resource status information.

22.-30. (canceled)

31. A second network node capable of operating in shared spectrum, the network node comprising processing circuitry operable to:
receive radio resource status information from a first network node, wherein the radio resource status information comprises channel occupancy information for one or more wireless devices associated with the first network node; and
perform a mobility load balancing (MLB) operation based on the radio resource status information.

32. The second network node of claim 31, wherein the radio resource status information comprises one or more of:
an indication of a number of successful listen-before-talk (LBT) procedures; and
an indication of a number of failed LBT procedures.

33. The second network node of claim 31, wherein the radio resource status information comprises one or more of:
an indication of a total time spent monitoring a channel during LBT procedures;
an indication of an average time spent monitoring a channel during LBT procedures; and
an indication of an average number of idle monitoring intervals that precede a transmission.

34. The second network node of claim 31, wherein the radio resource status information comprises one or more of:
an indication of a contention window size used for an LBT procedure;
an indication of a defer duration used for an LBT procedure; and
an indication of a value of a counter that determines a number of idle sensing periods that precede a transmission.

35. The second network node of claim 31, wherein the radio resource status information comprises one or more of:
an indication of a number of occurrences of shared channel occupancy time (COT);
an indication of a total duration of shared COT occurrences; and
an indication of average duration of a shared COT occurrence.

36. The second network node of claim 31, wherein the radio resource status information comprises one or more of:
an indication of an average detected energy during failed LBT procedures;
an indication of an average detected energy during successful LBT procedures; and
an indication of an average difference between an energy detection (ED) threshold and detected energy for failed LBT procedures.

37. The second network node of claim 31, wherein the radio resource status information comprises an indication of an average delay of transmissions for which a first LBT procedure failed.

38. The second network node of claim 31, wherein the radio resource status information is related to only downlink, only uplink, or both uplink and downlink.

39. The second network node of claim 31, wherein the radio resource status information is separated by any one or more of channel access priority class, traffic type, physical channel, transport channel, and logical channel.

40. The second network node of claim 31, wherein the radio resource status information excludes information for LBT procedures preceding synchronization signal block (SSB) transmissions.
